(19) United States
(12) Patent Application Publication
(10) Pub. No.: US 2025/0353158 A1
(43) Pub. Date: Nov. 20, 2025

(54) CLUTCH MECHANISM AND POWER TOOL HAVING SAME

(71) Applicant: Black & Decker Inc., New Britain, CT (US)

(72) Inventors: David C. Tomayko, Ellicott City, MD (US); Joseph Patrick Kelleher, Parkville, MD (US); Jianhua Chen, Suzhou (CN); GuoQing Wang, Suzhou (CN)

(21) Appl. No.: 19/281,114

(22) Filed: Jul. 25, 2025

Related U.S. Application Data
(63) Continuation of application No. 18/046,744, filed on Oct. 14, 2022.
(60) Provisional application No. 63/263,712, filed on Nov. 8, 2021.

(51) Int. Cl. B25F 5/00; B25B 21/00; B25B 23/147

(52) U.S. Cl. CPC B25F 5/001; B25B 21/00; B25B 23/147

(57) ABSTRACT

A power-driven tool may include a clutch mechanism selectively provides for engagement between and transmission mechanism and an output mechanism of the tool. The clutch mechanism may include a variable rate, or a dual rate biasing mechanism. mechanism that transmits power from a motor to an output device. A speed selection mechanism may be coupled to the transmission mechanism, to control a speed reduction through the transmission mechanism, and an output speed of the tool. The transmission mechanism may employ a compound, stepped, planetary gear assembly, to provide for an axially compact arrangement of transmission mechanism components, to reduce an axial length of the tool. The speed selection mechanism may employ a multi-staged grounding device, corresponding to the reduced axial length of the transmission mechanism.

### CROSS-REFERENCE TO RELATED APPLICATION

This application is a continuation of, and claims priority to, U.S. patent Ser. No. 18/046,744, filed on Oct. 14, 2022, entitled “CLUTCH MECHANISM AND POWER TOOL HAVING SAME,” which claims priority to U.S. Provisional Patent Application No. 63/263,712, filed on Nov. 8, 2021, entitled “CLUTCH MECHANISM AND POWER TOOL HAVING SAME,” the disclosures of which are incorporated herein by reference in their entireties.

### FIELD

This document relates, generally, to a clutch mechanism, and in particular to a clutch mechanism for a power tool.

### BACKGROUND

A power-driven tool may output a force generated by a motor of the tool to perform an operation on a workpiece. Power-driven tools may operate at multiple different settings (speed settings, torque settings and the like) to accomplish different types of tasks. Power-driven tools may employ a transmission mechanism and a clutch mechanism, allowing for power from the motor to be output by an output device of the tool at different torques and/or speeds to accommodate a variety of different tasks with the same tool. A substantially linear operation profile of the clutch mechanism may produce inconsistencies in output torque settings, particularly at upper and lower end portions of the operation profile. A clutch mechanism having a variable operation profile may enhance utility and functionality of this type of power-driven tool, thus enhancing utility to the operator.

### SUMMARY

In one general aspect, a power-driven tool includes a motor; an output shaft; a transmission configured to transmit a torque generated by the motor to the output shaft; and a clutch configured to selectively disengage torque transfer from the transmission to the output shaft when an output torque exceeds a threshold torque value. The clutch may include a clutch selector actuatable to select the threshold torque value; a retaining ring moveably coupled to the selector to move relative to the transmission in response to selection of the threshold torque value by actuation of the selector; a clutch engagement member selectively engageable with a component of the transmission to interrupt torque transfer from the transmission to the output shaft; and a biasing mechanism coupled between the retaining ring and the clutch engagement member, the biasing mechanism including at least one spring member having a variable spring rate. A biasing force applied to the clutch engagement member by the biasing mechanism corresponds to the selected threshold torque value and can be varied in a non-linear manner in accordance with movement of the retaining ring that adjusts the biasing force in accordance with the variable spring rate.

In some implementations, the clutch engagement member is a ball or a pin that engages a ramped surface on the transmission. The clutch engagement member may also include a clutch plate disposed between the ball or pin and the biasing member. The selector may include a clutch collar that is rotatable relative to the housing. A clutch nut may be disposed between the clutch collar and the retaining ring. The clutch may also include a clutch housing with a threaded front end portion, the clutch nut threadably engaged with the threaded front end portion to be axially movable relative to the transmission.

In some implementations, the at least one spring member includes a dual coil spring, including a first coil portion having a first length and a first diameter; and a second coil portion having a second length that is different than the first length, and a second diameter that is different than the first diameter. The first coil portion may be positioned within the second coil portion and may be concentrically arranged with the second coil portion; the first length of the first coil portion is greater than the second length of the second coil portion; and the first diameter of the first coil portion is less than the second diameter of the second coil portion. The retaining ring may be moveable axially relative to the clutch engagement member such that at a first axial position of the retaining ring relative to the clutch engagement member, the first coil portion of the dual coil spring contacts the clutch engagement member and is compressed to exert a first biasing force on the clutch engagement member and the second coil portion of the dual coil spring is not compressed; and at a second axial position of the retaining ring relative to the clutch plate, both the first coil portion and the second coil portion of the dual coil spring contact the clutch engagement member and are compressed to exert a second biasing force on the clutch engagement member that is greater than the first biasing force. The first axial position may correspond to a first clutch setting corresponding to a first threshold value torque setting for the power-driven tool, and the second axial position may correspond to a second clutch setting corresponding to a second threshold value torque setting that is greater than the first output torque setting. In some implementations, the dual coil spring includes a first coil spring defining the first coil portion, and a second coil spring defining the second coil portion. In some implementations, the first coil portion follows a first helical pattern, and the second coil portion follows a second helical pattern that is opposite the first helical pattern of the first coil portion.

In some implementations, the at least one spring member includes a dual rate spring, including a first coil portion having a first spring rate; and a second coil portion coupled to the first coil portion and having a second spring rate. At a first axial position of the retaining ring relative to the clutch plate, the first coil portion of the dual rate spring may contact the clutch engagement member and be compressed, and the second coil portion is not compressed, such that the dual coil spring exerts a first biasing force corresponding to the first spring rate on clutch engagement member. At a second axial position of the retaining ring relative to the clutch engagement member, both the first coil portion and the second coil portion of the dual rate spring may be compressed, and the dual rate spring exerts a second biasing force corresponding to the second spring rate on the clutch engagement member, the second biasing force being greater than the first biasing force. The first axial position may correspond to a first clutch setting corresponding to a first output torque setting for the power-driven tool, and the second axial position may correspond to a second clutch setting corresponding to a second output torque setting that is greater than the first output torque setting. A first end of the first coil portion may be configured to selectively contact the clutch engagement member based on an axial position of the retaining ring relative to the clutch plate; a second end of the first coil portion may be coupled to a first end of the second coil portion such that the second coil portion extends from the first end of the first coil portion of the dual rate spring; and a second end of the second coil portion may be retained by a corresponding pin and recess defined in the retaining ring.

In some implementations, the at least one spring member includes a plurality of spring members, each of the plurality of spring members having a first end portion thereof configured to selectively contact the clutch engagement member based on an axial position of the retaining ring relative to the clutch plate, and a second end thereof retained by a corresponding pin and recess defined in the retaining ring. In some implementations, the at least one spring member includes a single spring member, the single spring member having a first end portion thereof configured to selectively contact the clutch engagement member based on an axial position of the retaining ring relative to the clutch plate, and a second end thereof retained by a corresponding pin and recess defined in the retaining ring.

In some implementations, the retaining ring is configured to move in a first axial direction in response to rotation of the clutch collar in a first rotational direction; and the retaining ring is configured to move in a second axial direction in response to rotation of the clutch collar in a second rotational direction. The at least one spring member may be configured to be compressed in response to movement of the retaining ring in the first axial direction to exert a biasing force on clutch engagement member; and compression of the at least one spring member may be configured to be released in response to movement of the retaining ring in the second axial direction to release the biasing force exerted on the clutch engagement member.

In some implementations, the at least one spring member includes a plurality of springs, including at least one first spring having a first length; and at least one second spring having a second length, the second length being different from the first length. The at least one first spring may be configured to exert a biasing force on the clutch engagement member at a first axial position of the retaining ring relative to the clutch engagement member; and the at least one second spring may be configured to exert a biasing force on the clutch engagement member at a second axial position of the retaining ring relative to the clutch engagement member. The at least one first spring may be configured to exert a biasing force on the clutch engagement member at a first axial position of the retaining ring relative to the clutch engagement member; and the at least one first spring and the at least one second spring may be configured to exert a biasing force on the clutch engagement member at a second axial position of the retaining ring relative to the clutch engagement member.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic illustration of an example power-driven tool.

FIG. 2A is a side view of an example power-driven tool, in accordance with implementations described herein.

FIG. 2B is an internal view of the example tool shown in FIG. 2A, with a portion of a housing removed, so that internal components are visible.

FIG. 3 is a close-in view of an example clutch mechanism including a biasing member.

FIG. 4 is a graph of output torque as a function of clutch setting for various example biasing members.

FIGS. 5A-5C are assembled perspective views of an example clutch mechanism coupled to an example transmission mechanism of a power-driven tool, such as the example power-driven tool 100 described above with respect to FIGS. 2A-3, in accordance with an implementation described herein.

FIG. 5D is a partially exploded view of the example clutch mechanism shown in FIGS. 5A-5C.

FIG. 5E is a fully exploded view of the example clutch mechanism shown in FIGS. 5A-5C.

FIG. 5F is a perspective view of an example retaining ring of the example clutch mechanism shown in FIGS. 5A-5E, in accordance with implementations described herein.

FIG. 5G is a perspective view illustrating interaction of an example clutch selector, an example clutch nut, and an example retaining ring of the example clutch mechanism shown in FIGS. 5A-5E, in accordance with implementations described herein.

FIGS. 6A and 6B are side views of an example arrangement of biasing members of an example biasing mechanism for a clutch mechanism of a power-driven tool, in accordance with implementations described herein.

FIG. 6C is a cross-sectional view taken alone line A-A of FIG. 6A.

FIGS. 7A-7C are side views of an example arrangement of biasing members of an example biasing mechanism for a clutch mechanism of a power-driven tool, in accordance with implementations described herein.

FIG. 7D is an exploded, partial perspective view of the example arrangement of biasing members shown in FIGS. 7A-7C.

FIGS. 7E and 7F are side views of example biasing members of the example biasing mechanism shown in FIGS. 7A-7C.

FIGS. 8A-8D are side views of an example arrangement of biasing members of an example biasing mechanism for a clutch mechanism of a power-driven tool, in accordance with implementations described herein.

FIG. 8E is a side view of an example biasing member of the example biasing mechanism shown in FIGS. 8A-8D.

### DETAILED DESCRIPTION

Power-driven tools such as, for example, drills, drivers, impact drills/drivers and other such power-driven tools, may apply torque to a workpiece to accomplish a task, with different tasks sometimes requiring different levels of output torque. In some examples, the power-driven tool may be configured to output variable or adjustable torque levels such that a torque level, or an amount of torque, to be output by the tool and/or applied to the workpiece to accomplish a particular task may be selected by the operator. In some examples, the power-driven tool may include a torque control device, or a torque limiting device, that may selectively engage the clutch mechanism and/or the transmission mechanism based on, for example, a torque level selected by an operator of the tool. In some examples, such a torque control device, or torque limiting device, may control a maximum amount of torque that is transmitted from a driving mechanism (i.e., a motor) to an output mechanism of the power-driven tool. Such a torque control device, or torque limiting device may cause the clutch mechanism to engage and disengage the output mechanism and/or the transmission mechanism based on the selected output torque level, or selected trip torque, for a particular task. This may allow the operator to apply a desired level of torque to a workpiece, a uniform level of torque to multiple portions of a workpiece (such as, for example, the tightening of multiple fasteners at a uniform torque level with respect to the workpiece), avoid over-torquing, and the like, thus enhancing functionality and utility of the power-driven tool. In a power-driven tool including a clutch mechanism that provides torque limiting functionality, in accordance with implementations described herein, a level or amount of torque output by the power-driven tool may be accurately and reliably controlled by a biasing mechanism of the clutch mechanism that provides for variable levels of biasing, based on a selected output torque level.

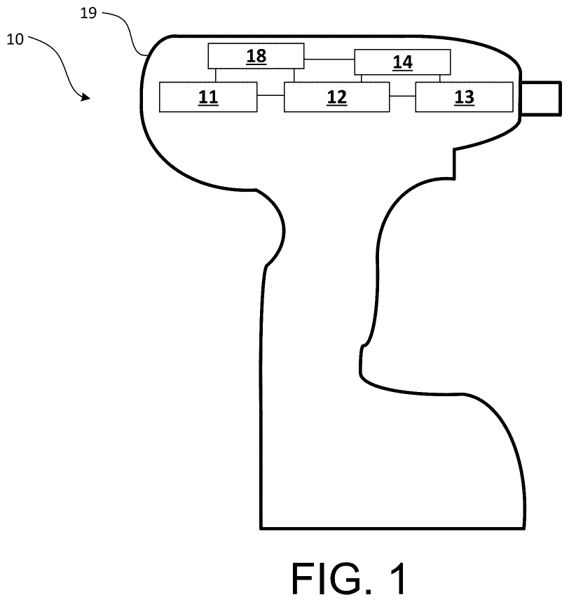

A schematic view of an example power-driven tool 10 is shown in FIG. 1. The example tool 10 includes a driving mechanism 11 generating a driving force, for example, a rotational driving force. In the example shown in FIG. 1, a transmission mechanism 12 is coupled to the driving mechanism 11, to transfer force, for example, rotational force, from the driving mechanism 11 to an output mechanism 13. A clutch mechanism 14 may be coupled, for example, between the transmission mechanism 12 and the output mechanism 13 and/or between the driving mechanism 11 and the transmission mechanism 12. The driving mechanism 11, the transmission mechanism 12, the output mechanism 13 and the clutch mechanism 14 may be received in a housing 19. A selection mechanism 18 may be coupled to the clutch mechanism 14 and/or the transmission mechanism 12 and/or the driving mechanism 11. The selection mechanism 18 may provide for user selection of an operation mode of the tool 10, an operation speed to be output by the tool 10, a torque level to be output by the tool 10, and the like. In some implementations, the driving mechanism 11 may be an electric motor that receives power from, for example, a power storage device (such as, for example, a battery), an external electrical power source, and the like. In some implementations, the driving mechanism 11 may be an air driven, or pneumatic motor, that is powered by compressed air introduced into the housing 19 from an external compressed air source. Other types of driving mechanisms, and other sources of power, may provide for power driven operation of the tool 10.

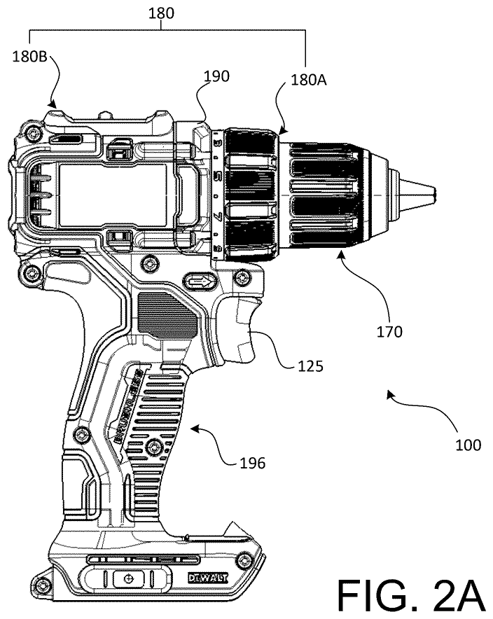

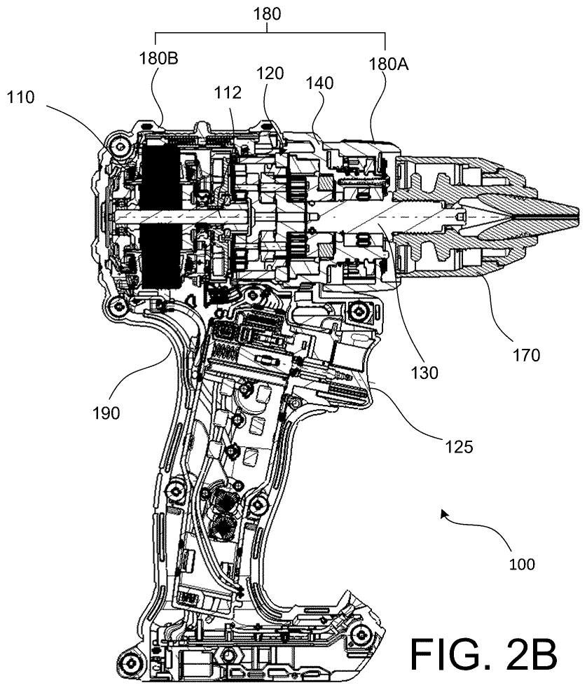

FIGS. 2A and 2B are side views of an example power-driven tool 100, in accordance with implementations described herein. FIG. 2B provides an internal view of the example tool 100, with a portion of a housing 190 shown in FIG. 2A partially removed, so that internal components of the example tool 100 are visible. The example tool 100 shown in FIGS. 2A and 2B includes a housing 190, with a chuck assembly 170 at an end portion of the housing 190, for example, at an end portion of the housing 190 corresponding to a working end of the tool 100. A trigger 125 for triggering operation of the tool 100 may be provided at a handle portion 196 of the housing 190. The example power-driven tool 100 shown in FIGS. 2A and 2B includes multiple selection mechanisms 180 provided on the housing 190 for user control of the tool 100. For example, a first selection mechanism 180A may provide for user selection of a torque setting, for example, a maximum torque setting, or a maximum torque level. The first selection mechanism 180A may be operably coupled to a clutch 140 received in the housing 190, to control a maximum torque level to be output by the tool 100. A second selection mechanism 180B may provide for user selection of an operating mode of the tool 100 such as, for example, an operating speed, an operating direction and the like.

The example power-driven tool 100 illustrated in FIGS. 2A and 2B is a driving tool, or a drill, simply for purposes of discussion and illustration. The principles to be described herein may be applied to other types of power-driven tools, including more, or fewer, components and/or features.

As shown in FIG. 2B, the example tool 100 may include a motor 110 received in the housing 190. The motor 110 may output a force, for example, a rotational force, via an output shaft 112, to a transmission 120. The transmission 120 may, in turn, transmit the rotary force from the motor 110 to an output mechanism 130, for example, an output shaft 130. An output tool (for example, a bit, a blade, and the like) may be coupled to the output shaft 130, and may be positioned outside of the housing 190 to perform an operation on a workpiece. The output tool may be coupled to the power-driven tool 100 by, for example, the chuck assembly 170, and driven by a force transmitted thereto by the output shaft 130.

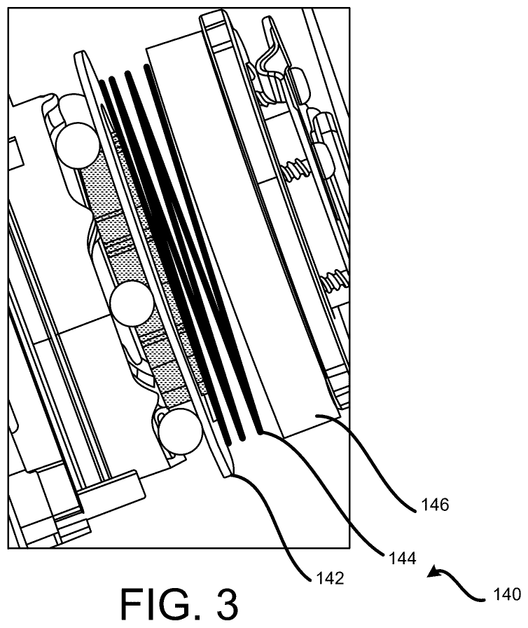

Referring also to FIG. 2B, in some examples, an output torque level may be set by the operator, for example through operator manipulation of the first selection mechanism 180A. Operator manipulation of the selection mechanism 180A may adjust an axial position of a retaining ring 146, which in turn may adjust compression of a biasing device 144 against a clutch plate 142. In the example shown in FIG. 3, the biasing device 144 is a single compression spring 144 retained between the clutch plate 142 and the retaining ring 146. An amount of axial pressure applied to the clutch plate 142 and corresponding axial movement of the clutch plate 142/interaction with the transmission 120 (in response to the operator manipulation of the selection mechanism 180A) may provide for engagement/disengagement of the clutch 140 and the transmission 120 in accordance with the selected output torque level.

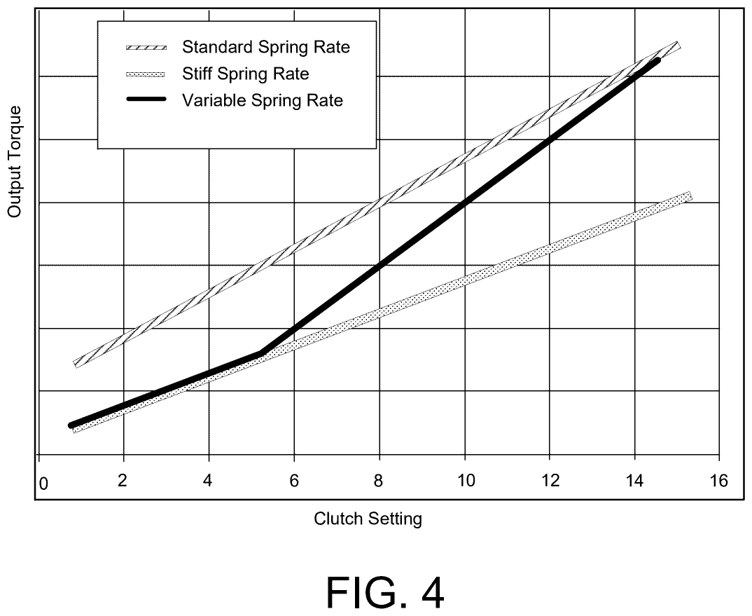

In some situations, the biasing device 144 in the form of the single compression spring 144, which provides a single spring rate, or a substantially uniform stiffness, may produce an output torque clutch setting that is too low for a high clutch setting, resulting in unintended disengagement at a lower output torque level than selected. In some cases, this may be addressed by using a compression spring having a greater stiffness. However, this may result in an output torque clutch setting that is too high for a low clutch setting, resulting in possible over-torquing. This is graphically illustrated in FIG. 4. As shown in FIG. 4, a biasing device having a variable spring rate, or a dual spring rate, may provide for output torque levels that are consistent with the selected clutch setting. In particular, as shown in FIG. 4, a biasing device having a non-linear spring rate, or a dual spring rate, or a variable spring rate, has a lower slope/lower spring constant/lower stiffness at lower clutch settings, and has a greater slope/greater spring constant/greater stiffness at higher clutch settings, allowing the device to achieve output torque along a relatively wide range of output torque levels.

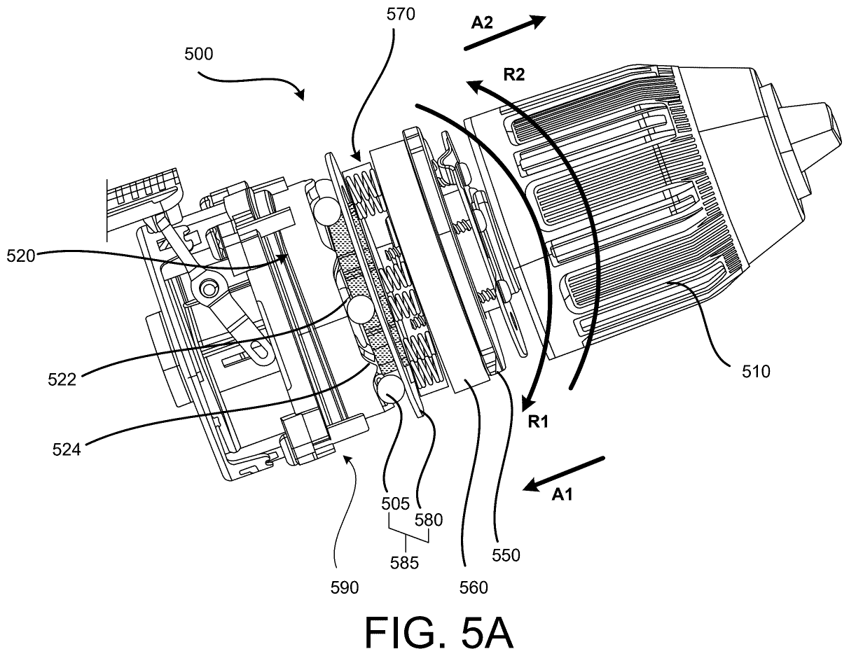

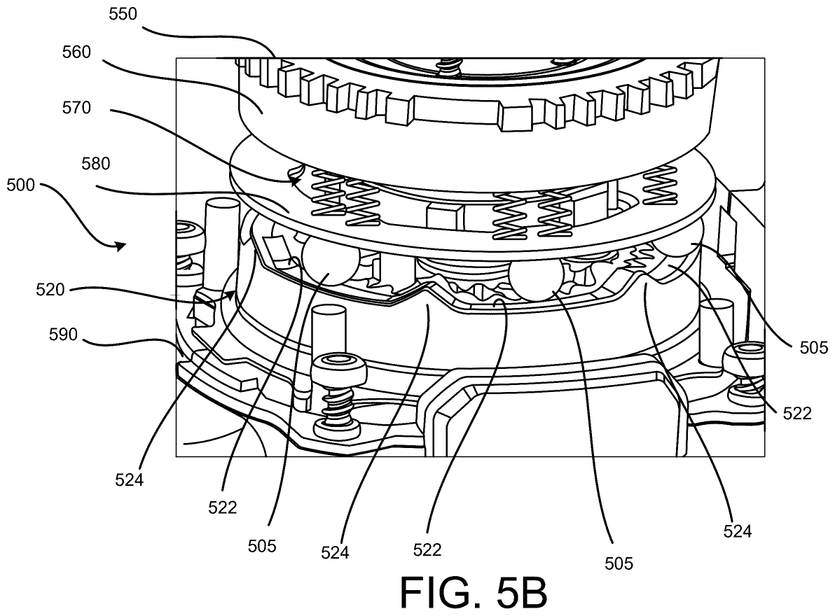

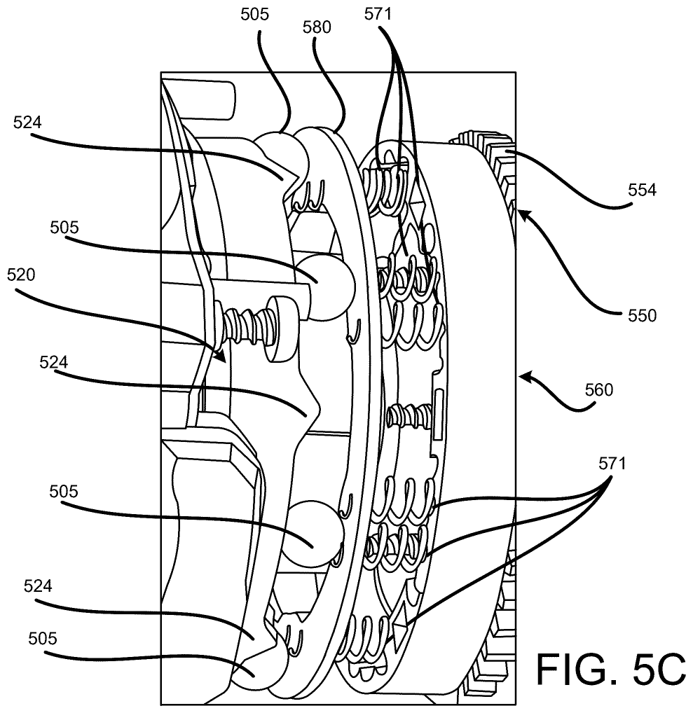

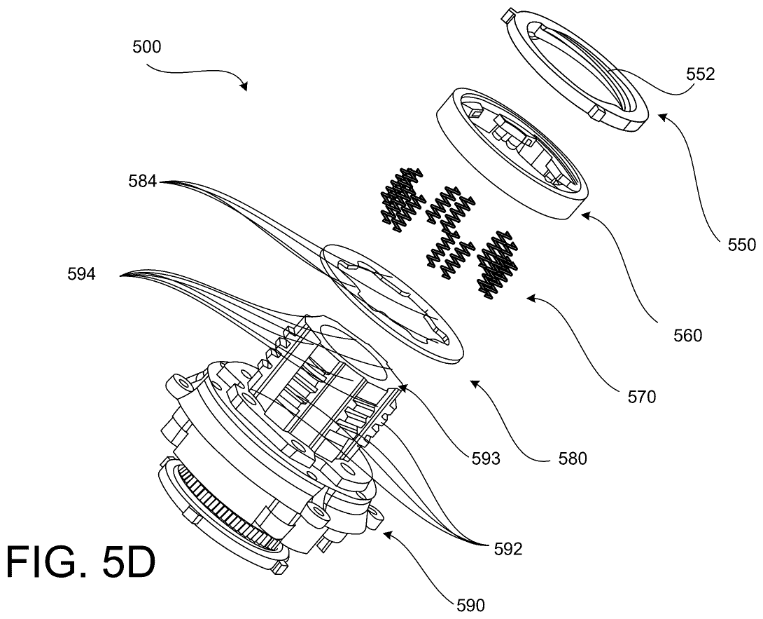

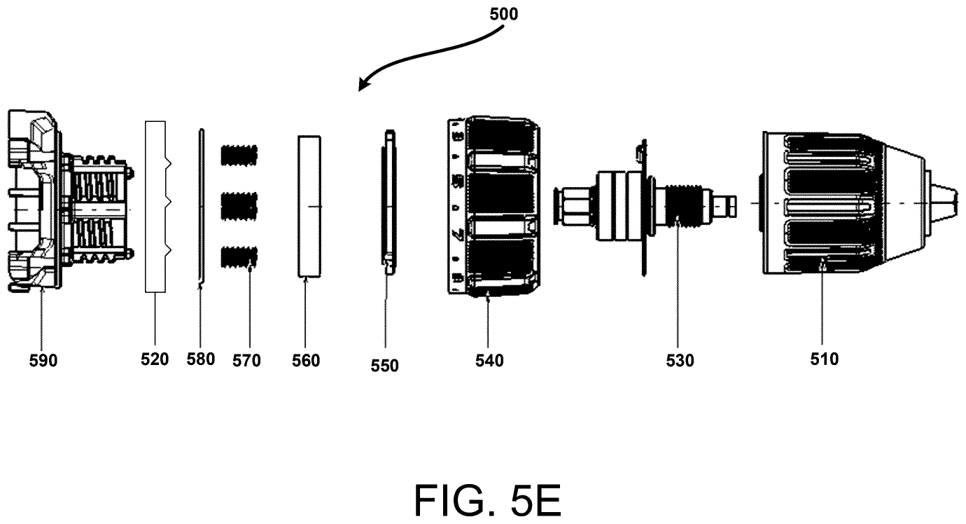

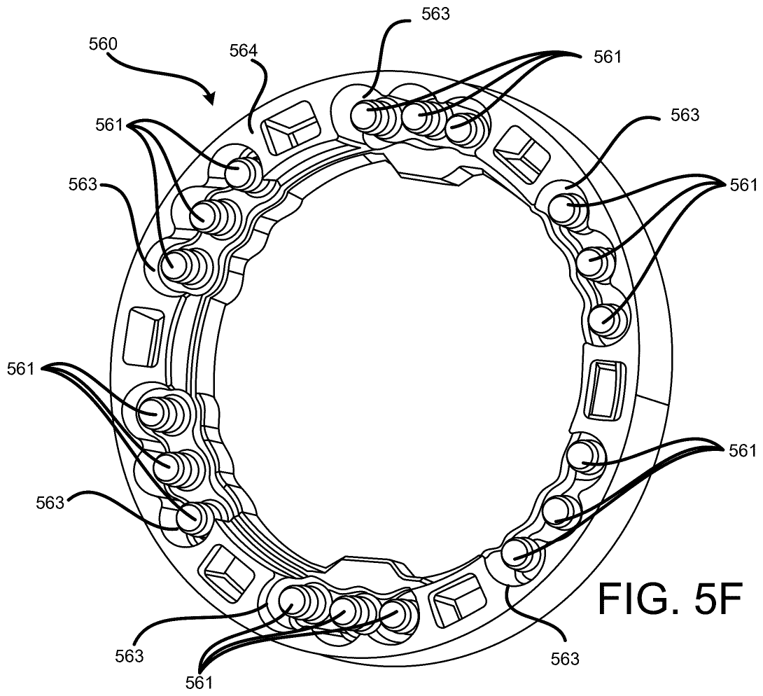

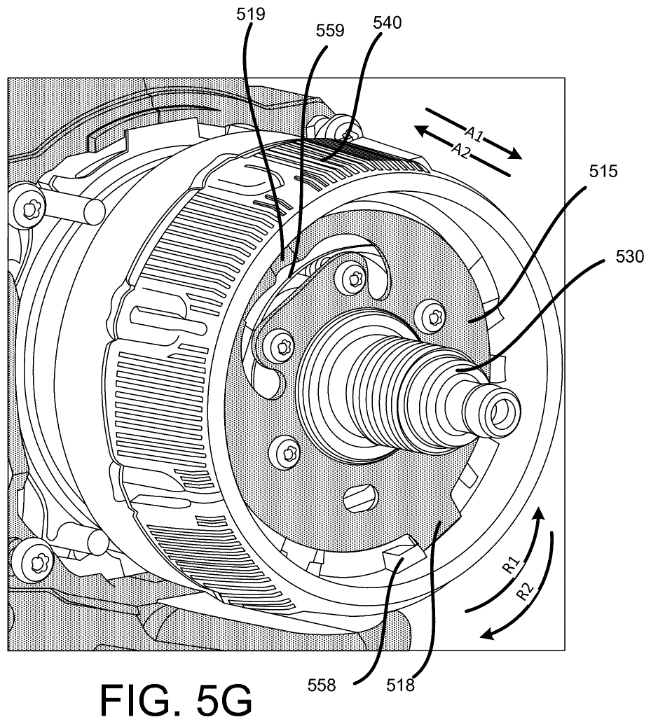

FIGS. 5A-5C are assembled perspective views of an example clutch coupled to an example transmission of a power-driven tool, such as the example power-driven tool 100 described above with respect to FIGS. 2A-3, in accordance with implementations described herein. In the views shown in FIGS. 5A-5C, a housing portion of the power-driven tool has been removed, so that components of the example clutch are visible. FIG. 5D is a partially exploded view, and FIG. 5E is a fully exploded view, of the example clutch shown in FIGS. 5A-5C. FIG. 5F is a perspective view of an example retaining ring 560 of the example clutch shown in FIGS. 5A-5E, in accordance with implementations described herein. FIG. 5G is a perspective view illustrating the operation of a clutch selector 540 including a rotatable clutch collar of the example clutch shown in FIGS. 5A-5E, in accordance with implementations described herein. The clutch selector 540 is actuatable by the operator to select a threshold torque value, or output torque value, or trip torque level, at which the clutch will disengage the transmission.

The example clutch 500 shown in FIGS. 5A-5E includes a biasing mechanism 570 positioned between a retaining ring 560 and a clutch engagement member 585 including a clutch plate 580 that selectively interacts with a plurality of balls 505 received in an output stage ring gear 520 of the transmission. In the example arrangement shown in FIGS. 5A-5E, the clutch plate 580 has a substantially annular shape and is positioned at a nose portion of a clutch housing 590. The clutch plate 580 applies a force (i.e., an axial force) to the balls 505, which are received in recessed portions 522 between ramped surfaces defined in a front face of the output stage ring gear 520 in response to a biasing force applied thereto by the biasing mechanism 570, to selectively retain the balls 505 in the recessed portions 522. The example biasing mechanism 570 shown in FIGS. 5A-5D includes a plurality of biasing members 571, or spring members 571. A first end portion of each spring member 571 may be retained by a corresponding pin 561 and spring recess 563 defined in a mating surface 564 of the retaining ring 560. The example arrangement of pins 561 and spring recesses 563 defined in the mating surface 564 of the retaining ring 560 shown in FIG. 5F is just one example of how the pins 561 and spring recesses 563 may be arranged. The retaining ring 560 may incorporate other arrangements of pins 561 and spring recesses 563 to accommodate the retention of other arrangements, sizes, combinations and the like of biasing members of a biasing mechanism in accordance with implementations described herein.

A clutch nut 550 is engaged between the retaining ring 560 and a clutch selector 540 (see FIGS. 5E and 5F). The clutch selector 540 is accessible from the outside of the tool, to provide for operator manipulation of the clutch selector 540. A threshold torque value, or output torque level, or trip torque level, may be selected through operator actuation, or manipulation, for example, rotation, of the clutch selector 540. In some examples, protrusions 554, or splines 554, or lugs 554 defined on an outer peripheral surface of the clutch nut 550 (see FIGS. 5C and 5D) engage with corresponding protrusions, or splines (not shown) formed on an inner peripheral surface of the clutch selector 540 to couple the clutch selector 540 and the clutch nut 550, and the retaining ring 560 coupled thereto. In some examples, the clutch nut 550 is fixed to the clutch selector 540, so that the clutch selector 540 and the clutch nut 550 rotate together for the setting of an output torque level, or trip torque level, or clutch setting via manipulation of the clutch selector 540. In some examples, a detent plate 515 (see FIG. 5G) is fixed to the housing of the power-driven tool. As the clutch selector 540 and clutch nut 550 are rotated, a protrusion 519, or detent 519, formed at an outer peripheral portion of the detent plate 515 moves along an inner peripheral surface of the clutch selector 540 and is received in one of a plurality of detent recesses 559 formed in the inner peripheral surface of the clutch selector 540. The plurality of detent recesses 559 formed in the inner peripheral surface of the clutch selector 540 may correspond to a plurality of clutch settings selectable via rotation of the clutch selector 540. In some examples, a stop 558 formed on the inner peripheral surface of the clutch selector 540 interacts with a tab 518 formed on the outer peripheral portion of the detent plate 515 to prevent over rotation of the clutch selector 540 in either the direction R1 or the direction R2.

A threaded interior portion 552 of the clutch nut 550 may be engaged with threaded portions 592 on a front protruding portion 593 of the clutch housing 590. As the clutch nut 550 rotates in response to rotation of the clutch selector 540, the threaded engagement of the clutch nut 550 with the clutch housing 590 translates the rotational movement into axial movement.

Rotation of the clutch selector 540 in a first rotational direction R1 causes corresponding rotation of the clutch nut 550 and the retaining ring 560, and axial movement of the clutch nut 550 and retaining ring 560 in a first axial direction A1. The axial movement of the clutch nut 550 and retaining ring 560 in turn causes compression of the biasing mechanism 570. The compression of the biasing mechanism 570 causes a first force to be exerted on the clutch plate 580. The first force exerted on the clutch plate 580 may position the clutch plate 580 so as to exert a force on the plurality of balls 505 received in the channels 522 of the output stage ring gear 520, to retain the balls 505 in the channels 522. Rotation of the clutch plate 580 may be restricted by the positioning of one or more protrusions 584 of the clutch plate 580 in a corresponding one or more recesses 594 formed in the clutch housing 590.

During operation of the tool, the clutch 500 may selectively provide for engagement between the transmission and the output shaft 530 (to in turn drive an output tool secured in the chuck 510). That is, an amount of compression of the biasing mechanism 570 (and corresponding magnitude of the biasing force exerted on the clutch plate 580) may correspond to a set output torque level, or trip torque, selected via manipulation (i.e., rotation) of the clutch selector 540. As the clutch nut 550 and retaining ring 560 move further in the first axial direction A1, the amount of compression of the biasing mechanism 570 (and corresponding force exerted on the clutch plate 580) increases.

As the force exerted on the clutch plate 580 increases (corresponding to an increased output torque level), an amount of torque required to cause the balls 505 to travel in the channels 522 and over ramped portions 524 of the output stage ring gear 520, to cause disengagement of the clutch 500, also increases. Once disengaged, force is no longer transmitted from the transmission to the output shaft 530. That is, when a level of torque output by the transmission is greater than the selected torque level, the biasing force retaining the balls 505 in the channels 522 of the output stage ring gear 520 is overcome, and balls 505 travel over the ramped portions 524, allowing the output stage ring gear 520 to spin freely. This disengages the output of the transmission from the output shaft 530, so that torque is no longer transmitted from the transmission to the output shaft 530.

In a similar manner, rotation of the clutch selector 540 in a second rotational direction R2 (opposite the first rotational direction R1) may cause axial movement of the clutch nut 550 and the retaining ring 560 in a second axial direction A2 (opposite the first axial direction A1). As the clutch nut 550 and retaining ring 560 move further in the second axial direction A2, the amount of compression of the biasing mechanism 570 (and corresponding force exerted on the clutch plate 580) decreases. The decreased force exerted on the clutch plate 580 in turn decreases an amount of torque that will cause the balls 505 to travel in the channels 522 and over the ramped portions 524 of the output stage ring gear 520, causing disengagement of the clutch 500 such that force is no longer transmitted from the transmission to the output shaft 530.

As described above with respect to FIG. 4, a biasing mechanism having a single spring rate, or a substantially uniform stiffness (such as the example biasing device 144 in the form of the single spring 144 shown in FIG. 3) may produce an output torque clutch setting that is too low for a high clutch setting, resulting in unintended disengagement at a lower output torque level than selected. Increasing stiffness of the biasing mechanism may result in an output torque clutch setting that is too high for a low clutch setting, resulting in greater output torque levels than desired, or over-torquing. A biasing mechanism, in accordance with implementations described herein, may employ a variable overall spring rate, to provide for output torque levels that are consistent with the selected clutch setting.

In the example arrangement shown in FIGS. 5A-5D, the biasing mechanism 570 includes a plurality of coil spring members having a first end thereof retained by the retaining ring 560. A second end of one or more of the coil spring members selectively contacts the clutch plate 580, depending on an axial position of the retaining ring 560 and the clutch nut 550 (based on the selected output torque corresponding to the rotational position of the clutch selector 540).

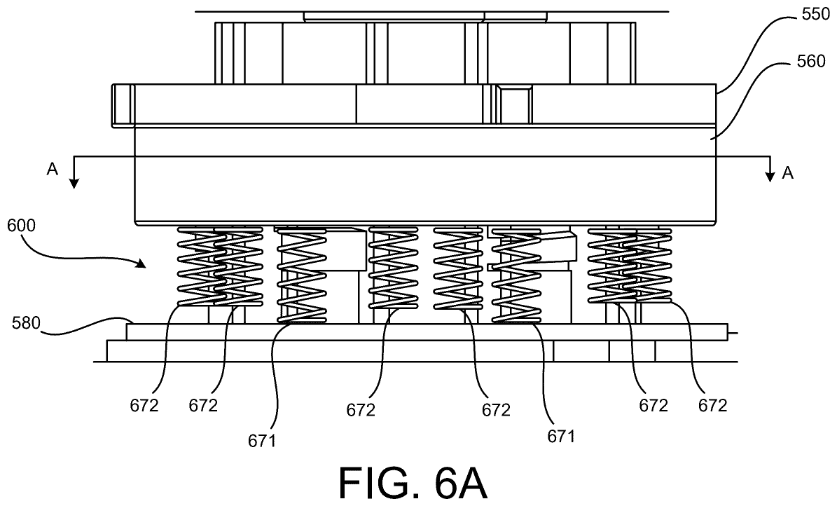

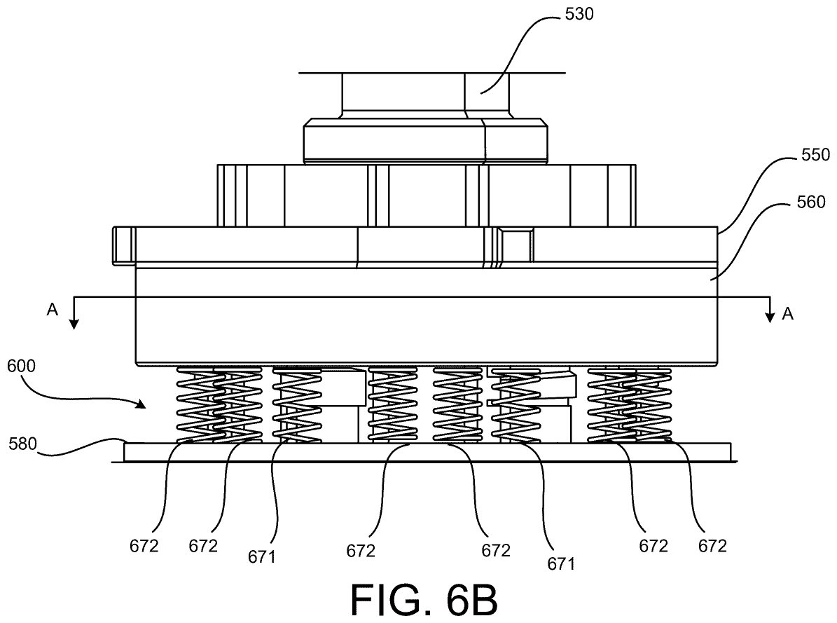

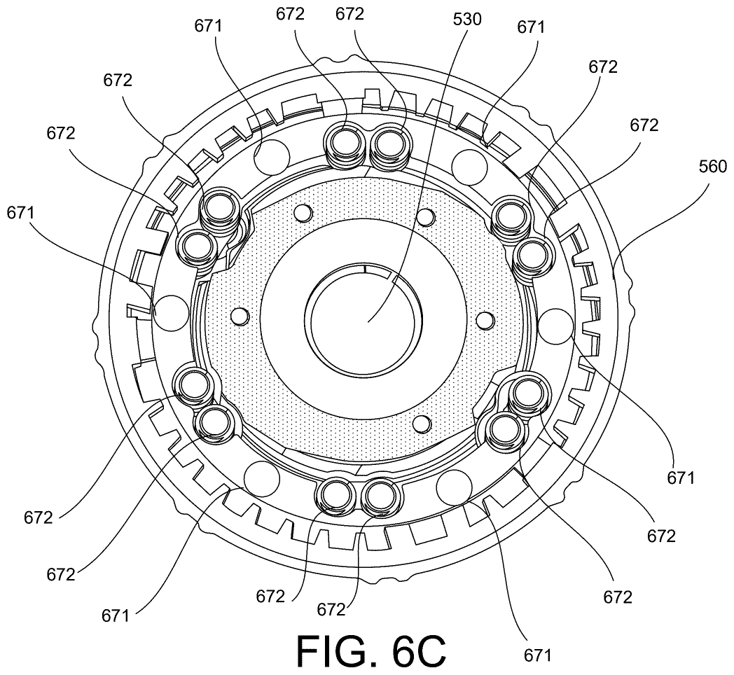

FIGS. 6A and 6B are side views of an example arrangement of biasing members of an example biasing mechanism 600 for a clutch of a power-driven tool, such as the clutch 500 described above with respect to FIGS. 5A-5D. FIG. 6C is a cross-sectional view taken alone line A-A of FIG. 6A. The example biasing mechanism 600, in accordance with implementations described herein, provides a variable, or non-linear, or dual spring rate, allowing the device to achieve a desired output torque along a relatively wide range of output torque levels.

As shown in FIGS. 6A-6C, in some implementations, the biasing mechanism 600 includes a plurality of first biasing members 671, or first coil spring members 671, and a plurality of second biasing members 672, or second coil spring members 672. In the example arrangement shown in FIGS. 6A-6C, the first coils spring members 671 and the second coil spring members 672 are arranged circumferentially about an axis defined by the output shaft 530. In the example arrangement shown in FIGS. 6A-6C, a first coil spring member 671 is positioned between two adjacent pairs of second coil spring members 672, simply for purposes of discussion and illustration. The biasing mechanism 600 can include more, or fewer first coil spring members 671, and/or more, or fewer second coil spring members 672 than shown in FIGS. 6A-6C, and/or different combinations and/or arrangements of first coil spring members 671 and second coil spring members 672.

As shown in FIG. 6A, a length of the first coil spring members 671 is greater than a length of the second coil spring members 672. FIG. 6A illustrates the first coil spring members 671 and the second coil spring members 672 relative to the clutch nut 550, the retaining ring 560 and the clutch plate 580 at a first clutch setting, for example, a low clutch setting corresponding to a low output torque level. At the first clutch setting, the first (longer) coil spring members 671 contact the clutch plate 580, thus imparting a first biasing force on the clutch plate 580, while the second (shorter) coil spring members 672 do not contact the clutch plate 580, and thus do not exert any biasing force on the clutch plate 580.

FIG. 6B illustrates the first coil spring members 671 and the second coil spring members 672 relative to the clutch nut 550, the retaining ring 560 and the clutch plate 580 at a second clutch setting, for example a clutch setting that is higher than the first clutch setting, corresponding to a higher output torque level than shown in FIG. 6A. At the second clutch setting, the clutch nut 550/retaining ring 560 has moved axially closer to the clutch plate 580, so that the first (longer) coil spring members 671 and the second (shorter) coil spring members 672 together impart a second biasing force on the clutch plate 580 that is greater than the first biasing force described with respect to FIG. 6A.

The example biasing mechanism 600 includes the first coil spring members 671 and second coil spring members 672, simply for purposes of discussion and illustration. In some implementations, the biasing mechanism 600 can include additional coil spring members having different lengths than the first coil spring members 671 and the second coil spring members 672. This may allow for additional variation in the spring rate provided by the biasing mechanism 600.

The combination of the first (longer) coil spring members 671 and the second (shorter) coil spring members 672 in the example biasing mechanism 600 provides a variable, or non-linear, or dual spring rate. Coupled with the varying degrees of biasing force generated by the first coil spring members 671 and the second coil spring members 672 depending on the relative position of the clutch nut 550/retaining ring 560 and the clutch plate 580 and the corresponding amount of compression of the first and second coil spring members 671, 672, this allows the tool to output a desired output torque along a relatively wide range of output torque levels.

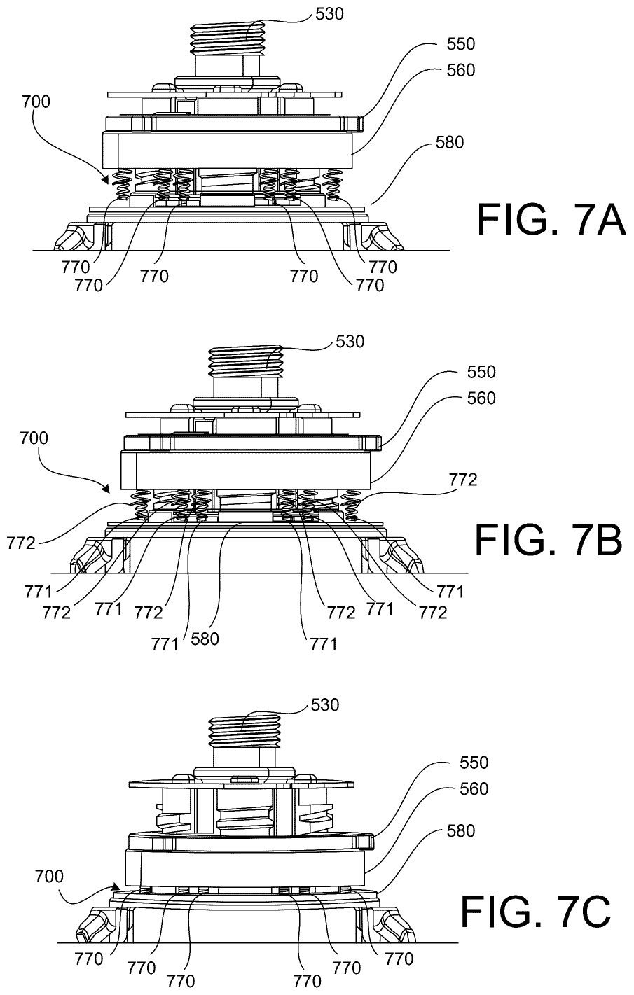

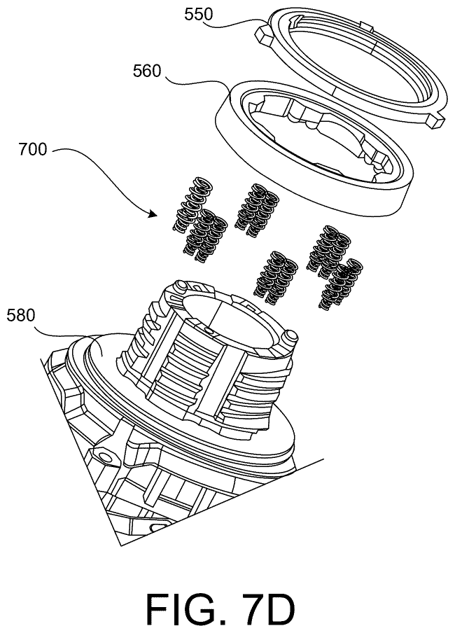

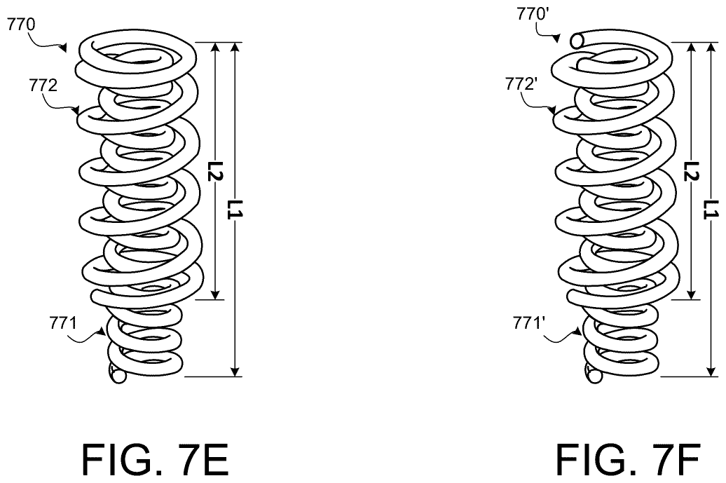

FIGS. 7A-7C are side views of an example arrangement of biasing members of an example biasing mechanism 700 for a clutch of a power-driven tool, such as the clutch 500 described above with respect to FIGS. 5A-5D. FIG. 7D is an exploded perspective view of the example arrangement of biasing members of the example biasing mechanism 700 shown in FIGS. 7A-7C. FIGS. 7D and 7E are side views of example spring members 770′ and 770′ that can be used in the example biasing mechanism 700 shown in FIGS. 7A-7D. The example biasing mechanism 700, in accordance with implementations described herein, provides a variable, or non-linear, or dual spring rate, allowing the device to achieve a desired output torque along a relatively wide range of output torque levels.

FIG. 7E illustrates an example spring member 770, which can be incorporated into the example biasing mechanism 700 shown in FIGS. 7A-7D. In some implementations, the example spring member 770 can replace some or all of the coil spring members 671, 672 of the example biasing mechanism 600 shown in FIGS. 6A-6C. In some implementations, the example spring member 770 shown in FIG. 7E can replace some of the coil spring members 671, 672 of the example biasing mechanism 600 shown in FIGS. 6A-6C such that the biasing mechanism includes a combination of spring members, including one or more of the coil spring members 671, 672 and one or more of the spring members 770.

The example spring member 770 shown in FIG. 7E is a double coil spring member 770 including a first coil portion 771 and a second coil portion 772. In the example shown in FIG. 7E, a diameter, of the first coil portion 771 is less than a diameter of the second coil portion 772. In the example shown in FIG. 7D, the first coil portion 771 and the second coil portion 772 are substantially concentric, with the second coil portion 772 positioned outside of the first coil portion 771. In the example shown in FIG. 7E, a helix pattern of the first coil portion 771 is different, for example, opposite a helix pattern of the second coil portion 772. For example, a first coil portion 771 having a right-hand pattern and a second coil portion 772 having an opposite, left-hand pattern may allow the example double coil spring member 770 to operate without the coils of the first coil portion 771 interfering with the coils of the second coil portion 772 as the first and second coil portions 771, 772 are independently compressed and released.

As shown in FIG. 7F, in some examples, a double coil spring member 770′ may include a first spring defining the first coil portion 771′ and a separate second spring defining the second coil portion 772′, the first and second springs having different lengths and different diameters consistent with the description provided above with respect to the first and second coil portions 771, 772 of the double coil spring member 770 shown in FIG. 7E.

Hereinafter, simply for purposes of discussion and illustration, the example biasing mechanism 700 will be described with respect to the double coil spring member 770. The principles to be described can be similarly applied to a biasing mechanism 700 including the double coil spring member 770′.

The example biasing mechanism 700 includes spring members 770 each including the first coil portion 771 and the second coil portion 772, simply for purposes of discussion and illustration. In some implementations, the biasing mechanism 700 can include additional coil portions, for example additional coil portions having different diameters and/or lengths that the first coil portion 771 and the second coil portion 772. This may allow for additional variation in the spring rate provided by the biasing mechansim 700.

In FIGS. 7E and 7F, the example spring members 770, 770′ are in an at rest state, corresponding to a disengaged state of the clutch shown in FIG. 7A. In the at rest state of the example spring member 770/770′, a length L1 of the first coil portion 771/771′ is greater than a length L2 of the second coil portion 772/772′. In the at rest state of the example spring member 770/770′ corresponding to the disengaged state of the clutch mechanism shown in FIG. 7A, the clutch nut 550/retaining ring 560 and clutch plate 580 are positioned such that neither the first coil portion 771/771′ nor the second coil portion 772/772′ is contacting, or engaged with the clutch plate 580.

FIG. 7B illustrates the double coil spring members 770 (or 770′) relative to the clutch nut 550, the retaining ring 560 and the clutch plate 580 at a first clutch setting, for example, a low clutch setting corresponding to a low output torque level. At the first clutch setting, the clutch nut 550/retaining ring 560 has moved axially closer to the clutch plate 580. At the first clutch setting, the first (longer) coil portion 771/771′ of each of the double coil spring members 770/770′ contacts the clutch plate 580, thus imparting a first biasing force on the clutch plate 580. At the first clutch setting shown in FIG. 7B, the second (shorter) coil portions 772/772′ of each of the double coil spring members 770/770′ do not contact the clutch plate 580, and thus do not exert any biasing force on the clutch plate 580. Thus, at the first clutch setting shown in FIG. 7B, only the first coil portion 771/771′ of each of the double coil spring members 770/770′ imparts any force on the clutch plate 580.

FIG. 7C illustrates the double coil spring members 770/770′ relative to the clutch nut 550, the retaining ring 560 and the clutch plate 580 at a second clutch setting, for example a clutch setting that is higher than the first clutch setting, corresponding to a higher output torque level, or trip torque, than shown in FIG. 7B. At the second clutch setting, the clutch nut 550/retaining ring 560 has moved axially closer to the clutch plate 580, so that the first (longer) coil portion 771/771′ and the second (shorter) coil portion 772/772′ together impart a second biasing force on the clutch plate 580 that is greater than the first biasing force described with respect to FIG. 7B. At the second clutch setting, the first coil portion 771/771′is more compressed than at the first clutch setting shown in FIG. 7B, thus exerting a greater biasing force at the second clutch setting than at the first clutch setting, with the compression of the second coil portion 772/772′ of the double coil spring members 770/770′ now also contributing to the biasing force exerted on the clutch plate 580.

The example biasing mechanism 700 shown in FIGS. 7A-7F includes a plurality of double coil spring members 770 and/or 770′, simply for ease of discussion and illustration. As noted above, the biasing mechanism 700 can include a combination of different types and/or arrangements and/or numbers of biasing members including the double coil spring members 770 and/or 770′. In some examples, a single, larger double coil spring members 770/770′ having the first coil portion 771/771′ and the second coil portion 772/772′ as described above may replace the single biasing device 144 shown in FIG. 3. The example biasing mechanism 700 has been described with respect to the use of the dual coil spring members 770/770′, simply for ease of discussion and illustration. The principles described with respect to the biasing mechanism 700 may be applied to spring members having multiple spring rates other than the dual spring rate as described (for example, triple spring rates, quadruple spring rates, and the like), non-linear spring rates, and the like.

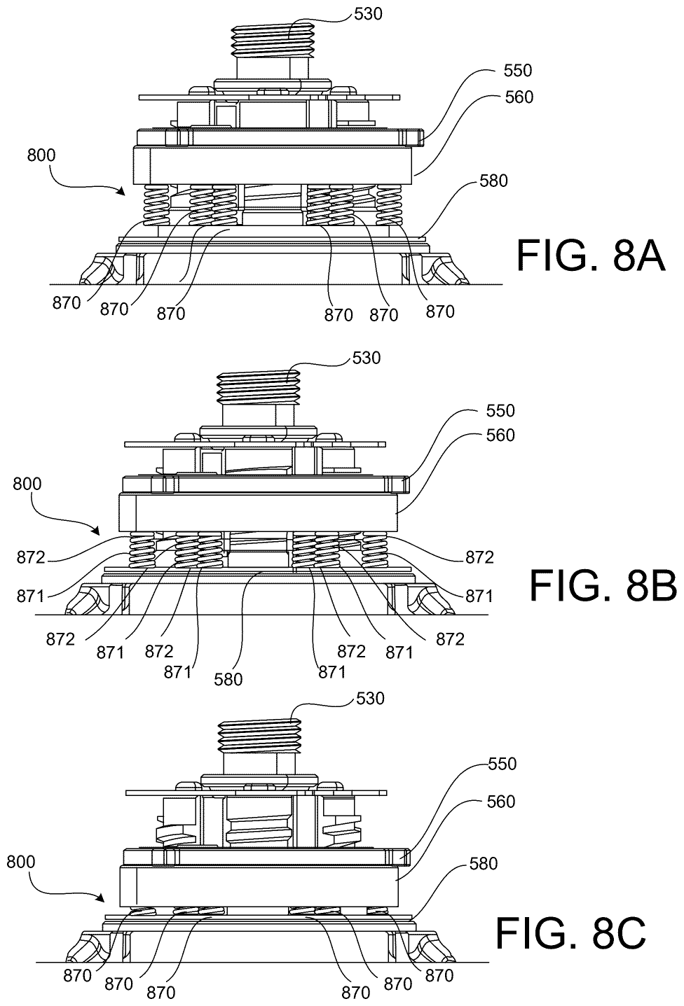

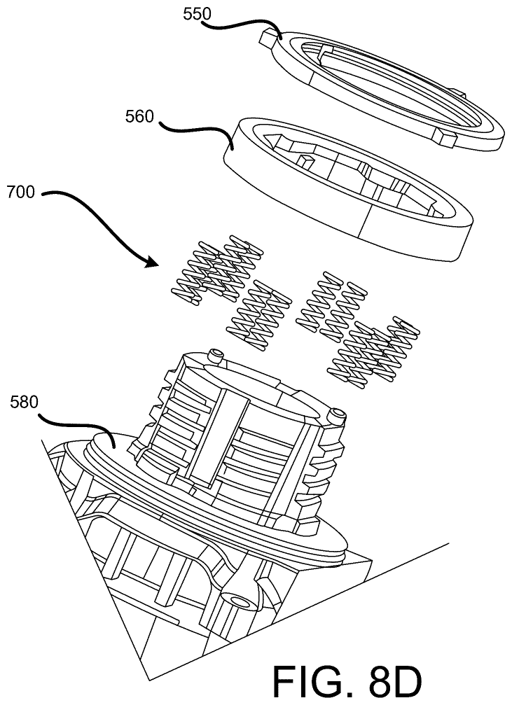

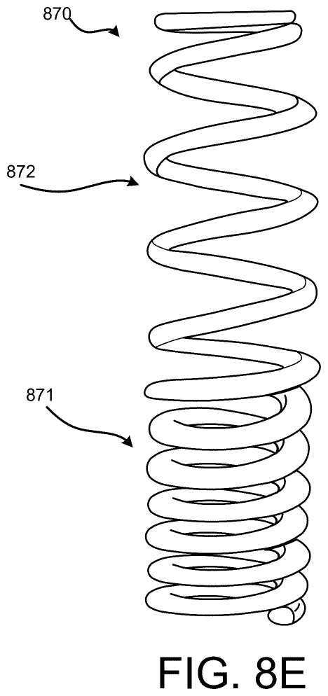

FIGS. 8A-8C are side views of an example arrangement of biasing members of an example biasing mechanism 800 for a clutch of a power-driven tool, such as the clutch 500 described above with respect to FIGS. 5A-5D. FIG. 8D is an exploded perspective view of the example arrangement of biasing members of the example biasing mechanism 800 shown in FIGS. 8A-8C. FIG. 8E is a side view of one of the example biasing members 870 of the example biasing mechanism 800 shown in FIGS. 8A-8D. The example biasing mechanism 800, in accordance with implementations described herein, provides a variable, or non-linear, or dual spring rate, allowing the device to achieve a desired output torque along a relatively wide range of output torque levels.

FIG. 8E illustrates an example spring member 870, and in particular an example dual rate spring member 870, which can be incorporated into the example biasing mechanism 800 shown in FIGS. 8A-8D. In some implementations, the example spring member 870 can replace some or all of the coil spring members 671, 672 of the example biasing mechanism 600 shown in FIGS. 6A-6C and/or some or all of the example double coil spring members 770 shown in FIGS. 7A-7F. In some implementations, the example spring member 870 shown in FIG. 8D can replace some of the coil spring members 671, 672 of the example biasing mechanism 600 shown in FIGS. 6A-6C and/or some or all of the example double coil spring members 770/770′ shown in FIGS. 7A-7F such that the biasing mechanism includes a combination of springs, including one or more of the coil spring members 671, 672 and/or one or more of the double coil spring members 770/770′ and/or one or more of the dual rate spring members 870. The example biasing mechanism 800 includes the spring members 870 each including the first coil portion 871 and the second coil portion 872, simply for purposes of discussion and illustration. In some implementations, the spring members 870 having additional coil portions incorporated into the spring member. This may allow for additional variation in the spring rate provided by the biasing mechanism 800.

The example spring member 870 shown in FIG. 8E is a dual rate spring member 870 including a first coil portion 871 and a second coil portion 872. In the example shown in FIG. 8E, the coils of the first coil portion 871 are arranged at a first pitch, and the coils of the second coil portion 872 are arranged at a second pitch that is greater than the first pitch, and a spring rate, or a stiffness of the first coil portion 871 is less than a spring rate, or a stiffness of the second coil portion 872. In the example shown in FIG. 8E, the first coil portion 871 and the second coil portion 872 are substantially concentric, with the first coil portion and the second coil portion 872 arranged end to end and aligned along substantially the same central axis as the first coil portion 871.

In FIG. 8E, the example spring member 870 is in an at rest state, corresponding to a disengaged state of the clutch shown in FIG. 8A. In the at rest state of the example spring member 870 corresponding to the disengaged state of the clutch shown in FIG. 8A, the clutch nut 550/retaining ring 560 and clutch plate 580 are positioned such that neither the first coil portion 771 nor the second coil portion 772 are compressed against the clutch plate 580.

FIG. 8B illustrates the dual rate spring members 870 relative to the clutch nut 550, the retaining ring 560 and the clutch plate 580 at a first clutch setting, for example, a low clutch setting corresponding to a low output torque level. At the first clutch setting, the clutch nut 550/retaining ring 560 has moved axially closer to the clutch plate 580. At the first clutch setting, the first coil portion 871 (having the lower stiffness) contacts the clutch plate 580, thus imparting a first biasing force on the clutch plate 580. At the first clutch setting shown in FIG. 8B, the second coil portions 872 of each of the dual rate spring members 870 are not compressed and do not exert any biasing force on the clutch plate 580. Thus, at the first clutch setting shown in FIG. 8B, only the first coil portion 871 of each of the dual rate spring members 870 imparts any force on the clutch plate 580.

As the clutch nut 550/retaining ring 560 moves axially closer to the clutch plate 580, the first coil portion 871 (having the lower stiffness) of each of the dual rate spring members 870 continues to be compressed and the pitch between adjacent coils of the first coil portion 871 continues to decrease. At the point at which the first coil portion 871 is substantially fully compressed, the second coil portion 872 (having the greater stiffness) will be compressed in response to continued axial movement of the clutch nut 550/retaining ring 560 toward the clutch plate 580.

FIG. 8C illustrates the dual rate spring members 870 relative to the clutch nut 550, the retaining ring 560 and the clutch plate 580 at a second clutch setting, for example a clutch setting that is higher than the first clutch setting, corresponding to a higher output torque level, or trip torque, than shown in FIG. 8B. At the second clutch setting, the clutch nut 550/retaining ring 560 has moved axially closer to the clutch plate 580, so that the first coil portion 871 (having the lower stiffness) and the second coil portion 872 (having the greater stiffness) together impart a second biasing force on the clutch plate 580 that is greater than the first biasing force described with respect to FIG. 8B. At the second clutch setting, both the first coil portion 871 and the second coil portion 872 are compressed and contribute to the biasing force exerted on the clutch plate 580.

The example biasing mechanism 800 shown in FIGS. 8A-8E includes a plurality of dual rate spring members 870, simply for ease of discussion and illustration. As noted above, the biasing mechanism 800 can include a combination of different types and/or arrangements and/or numbers of biasing members including the dual rate spring members 870. In some examples, a single, larger dual rate spring member 870 having the first coil portion 871 and the second coil portion 872 as described above may replace the single biasing device 144 shown in FIG. 3. The example biasing mechanism 800 has been described with respect to the use of the dual spring members 870 including the first coil portion 871 and the second coil portion 872, simply for ease of discussion and illustration. The principles described with respect to the biasing mechanism 800 may be applied to spring members having multiple coil portions other than the two coil portions as described (for example, three or more coil portions).

In a power-driven tool including a clutch that provides torque limiting functionality, in accordance with implementations described herein, a level or amount of torque output by the power-driven tool may be accurately and stably controlled by a biasing mechanism of the clutch that provides for variable levels of biasing, based on a selected output torque level.

In the following, some examples are described.
Example 1: A power-driven tool, including a motor; an output shaft; a transmission configured to transmit a torque generated by the motor to the output shaft; and a clutch configured to selectively disengage torque transfer from the transmission to the output shaft when an output torque exceeds a threshold torque value, the clutch including a clutch selector actuatable to select the threshold torque value; a retaining ring moveably coupled to the selector to move relative to the transmission in response to selection of the threshold torque value by actuation of the selector; a clutch engagement member selectively engageable with a component of the transmission to interrupt torque transfer from the transmission to the output shaft; and a biasing mechanism coupled between the retaining ring and the clutch engagement member, the biasing mechanism including at least one spring member having a variable spring rate, wherein a biasing force applied to the clutch engagement member by the biasing mechanism corresponds to the selected threshold torque value and can be varied in a non-linear manner in accordance with movement of the retaining ring that adjusts the biasing force in accordance with the variable spring rate.
Example 2: The power-driven tool of example 1, wherein the clutch engagement member comprises a ball or a pin that engages a ramped surface on the transmission.
Example 3: The power-driven tool of example 2, wherein the clutch engagement member further comprises a clutch plate disposed between the ball or pin and the biasing member.
Example 4: The power-driven tool of example 1, wherein the selector comprises a clutch collar that is rotatable relative to the housing.
Example 5: The power-driven tool of example 4, further comprising a clutch nut disposed between the clutch collar and the retaining ring.
Example 6: The power-driven tool of example 5, wherein the clutch further includes a clutch housing with a threaded front end portion, the clutch nut threadably engaged with the threaded front end portion to be axially movable relative to the transmission.
Example 7: The power-driven tool of example 1, wherein the at least one spring member includes a dual coil spring, including a first coil portion having a first length and a first diameter; and a second coil portion having a second length that is different than the first length, and a second diameter that is different than the first diameter.
Example 8: The power-driven tool of example 7, wherein the first coil portion is positioned within the second coil portion and is concentrically arranged with the second coil portion; the first length of the first coil portion is greater than the second length of the second coil portion; and the first diameter of the first coil portion is less than the second diameter of the second coil portion.
Example 9: The power-driven tool of example 8, wherein the retaining ring is moveable axially relative to the clutch engagement member such that at a first axial position of the retaining ring relative to the clutch engagement member, the first coil portion of the dual coil spring contacts the clutch engagement member and is compressed to exert a first biasing force on the clutch engagement member and the second coil portion of the dual coil spring is not compressed; and at a second axial position of the retaining ring relative to the clutch plate, both the first coil portion and the second coil portion of the dual coil spring contact the clutch engagement member and are compressed to exert a second biasing force on the clutch engagement member that is greater than the first biasing force.
Example 10: The power-driven tool of example 9, wherein the first axial position corresponds to a first clutch setting corresponding to a first threshold value torque setting for the power-driven tool, and the second axial position corresponds to a second clutch setting corresponding to a second threshold value torque setting that is greater than the first output torque setting.
Example 11: The power-driven tool of example 7, wherein the dual coil spring includes a first coil spring defining the first coil portion, and a second coil spring defining the second coil portion.
Example 12: The power-driven tool of example 7, wherein the first coil portion follows a first helical pattern, and the second coil portion follows a second helical pattern that is opposite the first helical pattern of the first coil portion.
Example 13: The power-driven tool of example 1, wherein the at least one spring member includes a dual rate spring, including a first coil portion having a first spring rate; and a second coil portion coupled to the first coil portion and having a second spring rate.
Example 14: The power-driven tool of example 13, wherein at a first axial position of the retaining ring relative to the clutch plate, the first coil portion of the dual rate spring contacts the clutch engagement member and is compressed, and the second coil portion is not compressed, such that the dual coil spring exerts a first biasing force corresponding to the first spring rate on clutch engagement member; and at a second axial position of the retaining ring relative to the clutch engagement member, both the first coil portion and the second coil portion of the dual rate spring are compressed, and the dual rate spring exerts a second biasing force corresponding to the second spring rate on the clutch engagement member, the second biasing force being greater than the first biasing force.
Example 15: The power-driven tool of example 14, wherein the first axial position corresponds to a first clutch setting corresponding to a first output torque setting for the power-driven tool, and the second axial position corresponds to a second clutch setting corresponding to a second output torque setting that is greater than the first output torque setting.
Example 16: The power-driven tool of example 13, wherein a first end of the first coil portion is configured to selectively contact the clutch engagement member based on an axial position of the retaining ring relative to the clutch plate; a second end of the first coil portion is coupled to a first end of the second coil portion such that the second coil portion extends from the first end of the first coil portion of the dual rate spring; and a second end of the second coil portion is retained by a corresponding pin and recess defined in the retaining ring.
Example 17: The power-driven tool of example 1, wherein the at least one spring member comprises a plurality of spring members, each of the plurality of spring members having a first end portion thereof configured to selectively contact the clutch engagement member based on an axial position of the retaining ring relative to the clutch plate, and a second end thereof retained by a corresponding pin and recess defined in the retaining ring.
Example 18: The power-driven tool of example 1, wherein the at least one spring member comprises a single spring member, the single spring member having a first end portion thereof configured to selectively contact the clutch engagement member based on an axial position of the retaining ring relative to the clutch plate, and a second end thereof retained by a corresponding pin and recess defined in the retaining ring.
Example 19: The power-driven tool of example 4, wherein the retaining ring is configured to move in a first axial direction in response to rotation of the clutch collar in a first rotational direction; and the retaining ring is configured to move in a second axial direction in response to rotation of the clutch collar in a second rotational direction.
Example 20: The power-driven tool of example 19, wherein the at least one spring member is configured to be compressed in response to movement of the retaining ring in the first axial direction to exert a biasing force on clutch engagement member; and compression of the at least one spring member is configured to be released in response to movement of the retaining ring in the second axial direction to release the biasing force exerted on the clutch engagement member.
Example 21: The power-driven tool of example 1, wherein the at least one spring member includes a plurality of springs, including at least one first spring having a first length; and at least one second spring having a second length, the second length being different from the first length.
Example 22: The power-driven tool of example 21, wherein the at least one first spring is configured to exert a biasing force on the clutch engagement member at a first axial position of the retaining ring relative to the clutch engagement member; and the at least one second spring is configured to exert a biasing force on the clutch engagement member at a second axial position of the retaining ring relative to the clutch engagement member. Example 23: The power-driven tool of example 21, wherein the at least one first spring is configured to exert a biasing force on the clutch engagement member at a first axial position of the retaining ring relative to the clutch engagement member; and the at least one first spring and the at least one second spring are configured to exert a biasing force on the clutch engagement member at a second axial position of the retaining ring relative to the clutch engagement member.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A power-driven tool, comprising:
a motor;
an output shaft;
a transmission configured to transmit a torque generated by the motor to the output shaft; and
a clutch configured to selectively disengage torque transfer from the transmission to the output shaft when an output torque exceeds a threshold torque value, the clutch including:
a clutch selector actuatable to select the threshold torque value;
a retaining ring moveably coupled to the clutch selector to move relative to the transmission in response to selection of the threshold torque value by actuation of the clutch selector;
a clutch engagement member selectively engageable with a component of the transmission to interrupt torque transfer from the transmission to the output shaft; and
a biasing mechanism coupled between the retaining ring and the clutch engagement member, the biasing mechanism including at least one spring member having a variable spring rate,
wherein a biasing force applied to the clutch engagement member by the biasing mechanism corresponds to the selected threshold torque value and can be varied in a non-linear manner in accordance with movement of the retaining ring that adjusts the biasing force in accordance with the variable spring rate.

2. The power-driven tool of claim 1, wherein the clutch engagement member comprises a ball or a pin that engages a ramped surface on the transmission.

3. The power-driven tool of claim 2, wherein the clutch engagement member further comprises a clutch plate disposed between the ball or pin and the biasing mechanism.

4. The power-driven tool of claim 1, wherein the clutch selector comprises a clutch collar that is rotatable relative to a housing of the power-driven tool.

5. The power-driven tool of claim 4, further comprising a clutch nut disposed between the clutch collar and the retaining ring.

6. The power-driven tool of claim 5, wherein the clutch further includes a clutch housing with a threaded front end portion, the clutch nut threadably engaged with the threaded front end portion to be axially movable relative to the transmission.

7. The power-driven tool of claim 1, wherein the at least one spring member includes a dual coil spring, the dual coil spring including:
a first coil portion having a first length and a first diameter; and
a second coil portion having a second length that is different than the first length, and a second diameter that is different than the first diameter.

8. The power-driven tool of claim 7, wherein
the first coil portion is positioned within the second coil portion and is concentrically arranged with the second coil portion;
the first length of the first coil portion is greater than the second length of the second coil portion; and
the first diameter of the first coil portion is less than the second diameter of the second coil portion.

9. The power-driven tool of claim 8, wherein the retaining ring is moveable axially relative to the clutch engagement member such that
at a first axial position of the retaining ring relative to the clutch engagement member, the first coil portion of the dual coil spring contacts the clutch engagement member and is compressed to exert a first biasing force on the clutch engagement member and the second coil portion of the dual coil spring is not compressed; and
at a second axial position of the retaining ring relative to a clutch plate of the clutch engagement member, both the first coil portion and the second coil portion of the dual coil spring contacts the clutch engagement member and are compressed to exert a second biasing force on the clutch engagement member that is greater than the first biasing force.

10. The power-driven tool of claim 9, wherein the first axial position corresponds to a first clutch setting corresponding to a first threshold value torque setting for the power-driven tool, and the second axial position corresponds to a second clutch setting corresponding to a second threshold value torque setting that is greater than the first threshold value torque setting.

11. The power-driven tool of claim 7, wherein the dual coil spring includes a first coil spring defining the first coil portion, and a second coil spring defining the second coil portion.

12. The power-driven tool of claim 7, wherein the first coil portion follows a first helical pattern, and the second coil portion follows a second helical pattern that is opposite the first helical pattern of the first coil portion.

13. The power-driven tool of claim 1, wherein the at least one spring member includes a dual rate spring, the dual rate spring including:
a first coil portion having a first spring rate; and
a second coil portion coupled to the first coil portion and having a second spring rate.

14. The power-driven tool of claim 13, wherein
at a first axial position of the retaining ring relative to a clutch plate of the clutch engagement member, the first coil portion of the dual rate spring contacts the clutch engagement member and is compressed, and the second coil portion is not compressed, such that the dual rate spring exerts a first biasing force corresponding to the first spring rate on clutch engagement member; and
at a second axial position of the retaining ring relative to the clutch engagement member, both the first coil portion and the second coil portion of the dual rate spring are compressed, and the dual rate spring exerts a second biasing force corresponding to the second spring rate on the clutch engagement member, the second biasing force being greater than the first biasing force.

15. The power-driven tool of claim 14, wherein the first axial position corresponds to a first clutch setting corresponding to a first output torque setting for the power-driven tool, and the second axial position corresponds to a second clutch setting corresponding to a second output torque setting that is greater than the first output torque setting.

16. The power-driven tool of claim 13, wherein
a first end of the first coil portion is configured to selectively contact the clutch engagement member based on an axial position of the retaining ring relative to the clutch engagement member;
a second end of the first coil portion is coupled to a first end of the second coil portion such that the second coil portion extends from the first end of the first coil portion of the dual rate spring; and
a second end of the second coil portion is retained by a corresponding pin and recess defined in the retaining ring.

17. The power-driven tool of claim 1, wherein the at least one spring member comprises a plurality of spring members, each of the plurality of spring members having a first end portion thereof configured to selectively contact the clutch engagement member based on an axial position of the retaining ring relative to a clutch plate of the clutch engagement member, and a second end thereof retained by a corresponding pin and recess defined in the retaining ring.

18. The power-driven tool of claim 1, wherein the at least one spring member comprises a single spring member, the single spring member having a first end portion thereof configured to selectively contact the clutch engagement member based on an axial position of the retaining ring relative to a clutch plate of the clutch engagement member, and a second end thereof retained by a corresponding pin and recess defined in the retaining ring.

19. The power-driven tool of claim 1, wherein the at least one spring member includes a plurality of springs, including:
at least one first spring having a first length, wherein the at least one first spring is configured to exert a biasing force on the clutch engagement member at a first axial position of the retaining ring relative to the clutch engagement member; and
at least one second spring having a second length, the second length being different from the first length, wherein the at least one second spring is configured to exert a biasing force on the clutch engagement member at a second axial position of the retaining ring relative to the clutch engagement member.

20. The power-driven tool of claim 1, wherein the at least one spring member includes a plurality of springs, including:
at least one first spring having a first length wherein the at least one first spring is configured to exert a biasing force on the clutch engagement member at a first axial position of the retaining ring relative to the clutch engagement member; and
at least one second spring having a second length, the second length being different from the first length wherein the at least one first spring and the at least one second spring are configured to exert a biasing force on the clutch engagement member at a second axial position of the retaining ring relative to the clutch engagement member.
